(19) United States
(12) Patent Application Publication
(10) Pub. No.: US 2022/0329562 A1
(43) Pub. Date: Oct. 13, 2022

(54) METHOD OF DETERMINING SERVICE TYPE OF NETWORK SERVICE

(71) Applicant: Jotun Technology Inc., Hsinchu City (TW)

(72) Inventors: Shun Yuan YANG, Hsinchu City (TW); Chiao Min HU, Hsinchu City (TW); Wei Teng TAI, Hsinchu City (TW)

(21) Appl. No.: 17/476,277

(22) Filed: Sep. 15, 2021

(30) Foreign Application Priority Data
Apr. 7, 2021 (TW) 110112493

(51) Int. Cl. H04L 29/12

(52) U.S. Cl. CPC H04L 61/1511; H04L 61/1552; H04L 61/1541

(57) ABSTRACT

A method is implemented by a router and includes: upon receiving a query on an Internet Protocol (IP) address for a domain name, sending the query to a DNS server in order for the DNS server to translate the domain name to an IP address and to transmit a DNS response containing the domain name and the IP address to the router; recording the domain name and the IP address in a table; sending the DNS response to an endpoint device so as to enable the endpoint device to establish a link with an application server via the router based on the IP address; finding the domain name in the lookup table based on the IP address; and determining a type of a service provided by the application server based on the domain name with reference to another table.

### CROSS-REFERENCE TO RELATED APPLICATION

This application claims priority of Taiwanese Invention Patent Application No. 110112493, filed on Apr. 7, 2021.

### FIELD

The disclosure relates to a method of determining a service type of a network service, and more particularly to a method of determining a service type of a network service to be implemented by a router.

### BACKGROUND

Conventionally, a service type of a network service may be determined by comparing a communication protocol used for the network service with each standard communication protocol. For example, a network service using port 20 and port 21 is related to File Transfer Protocol (FTP) for transfer of computer files from a server to a client device on a computer network, and a network service using port 80 is related to Hypertext Transfer Protocol (HTTP) for the World Wide Web.

Further, deep packet inspection (DPI) can also be used for determining a service type of a network service. However, DPI cannot be used for a secured network communication, in which data packets are encrypted. Moreover, DPI involves a massive amount of calculations and thus is time-consuming.

### SUMMARY

Therefore, an object of the disclosure is to provide a method of determining a service type of a network service that can alleviate at least one of the drawbacks of the prior art.

According to the disclosure, the method is to be implemented by a router, via which an endpoint device communicates with a Domain Name System (DNS) server and an application server. The method includes steps of:
upon receiving, from the endpoint device that intends to establish a communication link with the application server, a query on an Internet Protocol (IP) address for a domain name that is assigned to the application server, sending the query to the DNS server in order for the DNS server to translate the domain name included in the query to an IP address of the application server and to transmit a DNS response that contains the domain name and the IP address to the router;
recording the domain name and the IP address contained in the DNS response thus received in a domain-name-to-IP-address (DNIP) lookup table;
sending the DNS response to the endpoint device so as to enable the endpoint device to establish the communication link with the application server via the router based on the IP address contained in the DNS response;
finding the domain name of the application server that corresponds to the IP address in the DNIP lookup table; and
determining a service type of a network service provided by the application server based on the domain name thus found with reference to a domain-name-to-service-type (DNST) lookup table.

### BRIEF DESCRIPTION OF THE DRAWINGS

Other features and advantages of the disclosure will become apparent in the following detailed description of the embodiment with reference to the accompanying drawings, of which:

FIG. 1 is a schematic diagram illustrating an example of a system configured to implement a method of determining a service type of a network service according to an embodiment of the disclosure; and

FIG. 2 is a flow chart illustrating the method of determining a service type of a network service according to an embodiment of the disclosure.

### DETAILED DESCRIPTION

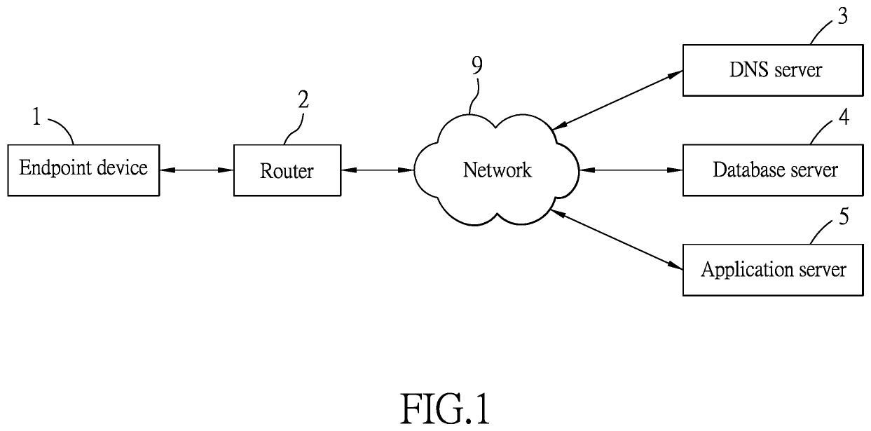

FIG. 1 illustrates an embodiment of a system that is configured to implement a method of determining a service type of a network service according to the disclosure. The system includes an endpoint device 1, a router 2, a Domain Name System (DNS) server 3, a database server 4 and an application server 5. The endpoint device is electrically connected to the router 2, and communicates with the DNS server 3, the database server 4 and the application server 5 via the router 2 through a network 9 (e.g., the Internet).

The endpoint device 1 may be embodied using a desktop computer, a laptop computer, a notebook computer, a tablet computer, a smartphone or any computing equipment that supports network communication, but implementation thereof is not limited to what are disclosed herein and may vary in other embodiments.

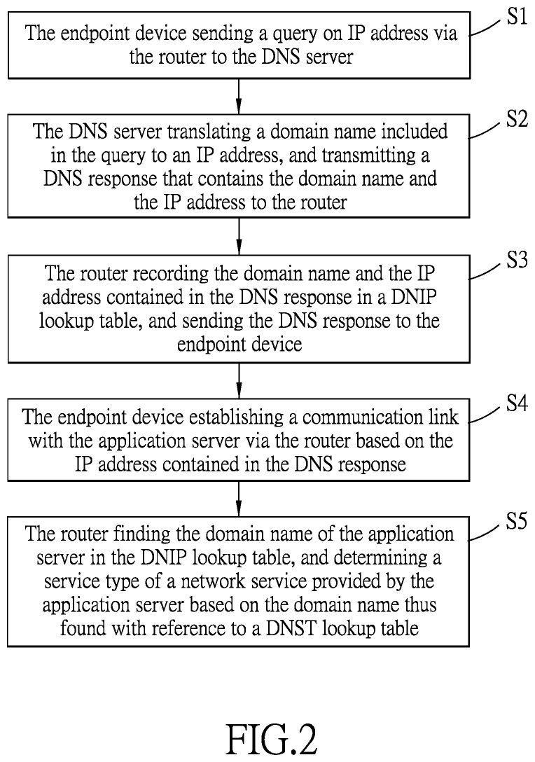

Referring to FIG. 2, an embodiment of the method of determining a service type of a network service according to the disclosure is illustrated. The method includes steps S1 to S5 delineated below.

In step S1, when the endpoint device 1 executing an application program (e.g., a program of streaming media player) intends to establish a communication link with the application server 5 (e.g., a provider of streaming media services) via the router 2 through the network 9, the endpoint device 1 sends via the router 2 to the DNS server 3 a query on an Internet Protocol (IP) address for a domain name that is assigned to the application server 5. Upon receiving the query from the endpoint device 1, the router 2 sends the query to the DNS server 3. Specifically, the query includes the domain name of the application server 5.

In step S2, the DNS server 3 translates the domain name included in the query to an IP address of the application server 5, and transmits a DNS response that contains the domain name and the IP address to the router 2.

In step S3, upon receiving the DNS response, the router 2 records the domain name and the IP address contained in the DNS response thus received in a domain-name-to-IP-address (DNIP) lookup table. In addition, the router 2 sends the DNS response to the endpoint device 1. It should be noted that the DNIP lookup table may include a plurality of domain names, and a plurality of IP addresses each corresponding to one of the plurality of domain names. An example of the DNIP lookup table is shown in Table 1 below.

TABLE 1

| Domain name | IP address |
|---|---|
| www.yahoo.com | 180.222.102.201 |
| www.yahoo.com | 180.222.102.202 |
| www.youtube.com | 172.217.24.14 |
| live.youtube.com | 172.217.24.14 |

It is worth to note that the router 2 will update the DNIP lookup table whenever the router 2 receives the DNS response, i.e., the domain name and the IP address contained in each of the DNS responses received by the router 2 will be added into the DNIP lookup table. Moreover, in the DNIP lookup table, one domain name may correspond to a plurality of different IP addresses (e.g., the domain name “www.yahoo.com” corresponding to two different IP addresses in Table 1), and a plurality of different domain names may correspond to one IP address (e.g., the domain names “www.youtube.com” and “live.youtube.com” corresponding to the same IP address in Table 1).

In step S4, upon receiving the DNS response from the router 2, the endpoint device 1 establishes the communication link with the application server 5 via the router 2 based on the IP address contained in the DNS response.

In step S5, the router 2 finds the domain name of the application server 5 in the DNIP lookup table based on the IP address, and determines a service type of a network service provided by the application server 5 based on the domain name thus found with reference to a domain-name-to-service-type (DNST) lookup table. An example of the DNST lookup table is shown in Table 2 below. In this embodiment, the service type of the network service provided by the application server 5 is determined to be one of web service, audio-video playing, online gaming, live streaming, and file download, but is not limited to what are disclosed herein.

TABLE 2

| Domain name | Service type |
|---|---|
| www.yahoo.com | Web service |
| www.youtube.com | Audio-video playing |
| live.youtube.com | Live streaming |

It is worth to note that in this embodiment, the router 2 obtains the IP address of the application server 5 from a data packet that is transmitted through the communication link between the endpoint device 1 and the application server 5, and finds the domain name of the application server 5 that corresponds to the IP address thus obtained in the DNIP lookup table. Specifically, the data packet contains a header including the IP addresses of a source and a destination (i.e., the endpoint device land the application server 5), and thus the router 2 can obtain the IP address of the application server 5 from the header of the data packet.

It is worth to note that in this embodiment, the method further includes a step of the router 2 storing the DNST lockup table in advance of determining a service type of a network service (step S5). Further, the database server 4 stores latest data of the DNST lockup table, and the method further includes steps of the router 2 communicating with the database server 4 to download the latest data of the DNST lookup table from the database server 4 and updating the DNST lookup table stored therein based on the latest data of the DNST lookup table obtained from the database server 4.

In one embodiment, the step of determining the service type of the network service provided by the application server 5 includes sub-steps of the router 2 communicating with the database server 4 that stores the DNST lookup table, obtaining the DNST lockup table from the database server 4, and finding a service type that corresponds to the domain name in the DNST lookup table thus obtained.

In one embodiment, the step of determining the service type of the network service provided by the application server 5 includes sub-steps of the router 2 communicating with the database server 4 that stores the DNST lookup table, and finding a service type that corresponds to the domain name in the DNST lookup table stored in the database server 4. Specifically, in this embodiment, the router 2 communicates with the database server 4 to access the DNST lookup table and to find the service type corresponding to the domain name directly from the DNST lookup table stored in the database server 4.

It should be noted that when the DNIP lookup table stored in the router 2 contains a plurality of domain names that all correspond to the same IP address contained in the DNS response, the step of finding the domain name of the application server 5 includes the router 2 selecting, from the DNIP lookup table based on a predefined criterion, one of the plurality of domain names that corresponds to the IP address to serve as the domain name of the application server 5. In one embodiment, the router 2 randomly selects one of the plurality of domain names to serve as the domain name of the application server 5. In one embodiment, the router 2 selects a predetermined one of the plurality of domain names (e.g., the first one of the plurality of domain names in the DNIP lookup table) to serve as the domain name of the application server 5. For example, see Table 1, domain names “www.youtube.com” and “live.youtube.com” both correspond to the IP address “172.217.24.14”, and the router 2 selects, from the DNIP lookup table, the first one of the domain names (i.e., www.youtube.com) that corresponds to the IP address (i.e., 172.217.24.14) to serve as the domain name of the application server 5.

In summary, by recording in the DNIP lookup table in advance a domain name and an IP address of an application server which are contained in a DNS response, the router 2 is able to find in the DNIP lookup table the domain name that corresponds to the IP address; further, the router 2 is able to determine a service type of a network service provided by the application server based on the domain name thus found with reference to the DNST lookup table. In this way, the router 2 can efficiently determine a service type of a network service. Moreover, such approach is suitable fora secured network communication, in which data packets are encrypted.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method of determining a service type of a network service, the method to be implemented by a router, via which an endpoint device communicates with a Domain Name System (DNS) server and an application server, the method comprising steps of:
upon receiving, from the endpoint device that intends to establish a communication link with the application server, a query on an Internet Protocol (IP) address for a domain name that is assigned to the application server, sending the query to the DNS server in order for the DNS server to translate the domain name included in the query to an IP address of the application server and to transmit a DNS response that contains the domain name and the IP address to the router;
recording the domain name and the IP address contained in the DNS response thus received in a domain-name-to-IP-address (DNIP) lookup table;
sending the DNS response to the endpoint device so as to enable the endpoint device to establish the communication link with the application server via the router based on the IP address contained in the DNS response;
finding the domain name of the application server in the DNIP lookup table based on the IP address; and
determining a service type of a network service provided by the application server based on the domain name thus found with reference to a domain-name-to-service-type (DNST) lockup table.

2. The method as claimed in claim 1, further comprising, before the step of determining a service type of a network service, a step of:
storing the DNST lookup table.

3. The method as claimed in claim 2, further comprising steps of:
communicating with a database server that stores latest data of the DNST lockup table; and
updating the DNST lookup table based on the latest data of the DNST lookup table stored in the database server.

4. The method as claimed in claim 1, wherein, when the DNIP lookup table stored in the router contains a plurality of domain names that all correspond to the IP address contained in the DNS response, the step of finding the domain name of the application server includes selecting, from the DNIP lookup table, one of the plurality of domain names that correspond to the IP address to serve as the domain name of the application server based on a predefined criterion.

5. The method as claimed in claim 4, wherein selecting one of the plurality of domain names to serve as the domain name of the application server is to randomly select one of the plurality of domain names to serve as the domain name of the application server.

6. The method as claimed in claim 4, wherein selecting one of the plurality of domain names to serve as the domain name of the application server is to select a predetermined one of the plurality of domain names to serve as the domain name of the application server.

7. The method as claimed in claim 1, wherein the step of determining a service type of a network service includes:
communicating with a database server that stores the DNST lookup table;
obtaining the DNST lookup table from the database server; and
finding a service type that corresponds to the domain name in the DNST lookup table.

8. The method as claimed in claim 1, wherein the step of determining a service type of a network service includes:
communicating with a database server that stores the DNST lookup table; and
finding a service type that corresponds to the domain name in the DNST lookup table stored in the database server.

9. The method as claimed in claim 1, wherein, in the step of determining a service type of a network service, the service type of the network service provided by the application server is determined to be one of web service, audio-video playing, online gaming, live streaming and file download.

10. The method as claimed in claim 1, wherein the step of finding the domain name of the application server includes:
obtaining the IP address of the application server from a data packet that is transmitted through the communication link between the endpoint device and the application server; and
finding the domain name of the application server that corresponds to the IP address thus obtained in the DNIP lookup table.
